(19) United States
(12) Patent Application Publication
(10) Pub. No.: US 2012/0087631 A1
(43) Pub. Date: Apr. 12, 2012

(54) ELECTRONIC APPARATUS AND CONTROL METHOD OF ELECTRONIC APPARATUS

(75) Inventor: Yoshinobu FUJIWARA, Oume-shi (JP)

(73) Assignee: Kabushiki Kaisha Toshiba, Tokyo (JP)

(21) Appl. No.: 13/198,437

(22) Filed: Aug. 4, 2011

(30) Foreign Application Priority Data
Oct. 6, 2010 (JP) P2010-226506

(51) Int. Cl. H04N 5/91

(52) U.S. Cl. 386/230; 386/E05.003

(57) ABSTRACT

According to one embodiment, an electronic apparatus includes: a combination information output module which outputs, to a server, information according to a combination between the electronic apparatus and an external device externally connected to the electronic apparatus; a notification receiver which receives a notification according to the combination between the electronic apparatus and the external device, which is output from the server; and a display module which displays, in a display, information based on the notification.

### CROSS REFERENCE TO RELATED APPLICATION(S)

The application is based upon and claims the benefit of priority from Japanese Patent Application No. 2010-226506 filed on Oct. 6, 2010; the entire content of which are incorporated herein by reference.

### FIELD

Embodiments described herein relate generally to an electronic apparatus to which a recording apparatus is connectable with external connection.

### BACKGROUND

In recent years, television sets in standard homes have been connected to the Internet with the popularization of broadband services, wireless local area networks (LANs), and portal services for distributing information contents and moving-image contents to digital television sets utilizing the broadband connection of the Internet.

In recent years, some of electronic apparatuses (e.g., television sets) in standard homes have had built-in recording apparatuses (e.g., hard disk), so that digital broadcast programs and video-images acquired from the Internet can be recorded in built-in recording apparatuses.

In addition, external recording apparatuses, such as a universally serial bus (USB) externally-connected hard disk drive apparatus (USB-connected HDD apparatus) and a LAN hard disk drive apparatus (LAN-connected HDD apparatus) connected to an in-home LAN, have been used as recording apparatuses. The video-images have been recorded in such apparatuses.

However, especially, in the case of external recording apparatuses, it is frequent that the external recording apparatus is manually mounted on an electric apparatus by a user himself. In this case, the electronic apparatus and the external recording apparatus are not always purchased at the same time. It is frequent that a user purchases individually the electronic apparatus and the external recording apparatus.

For example, when a certain electronic apparatus is connected to a certain external recording apparatus (or, a certain external recording apparatus is connected to a certain electronic apparatus), sometimes, actually, the electronic apparatus and the external recording apparatus of this combination are incompatible with each other.

One cause of the problems is described hereinafter. That is, e.g., when video data is recorded in a certain external recording apparatus by a certain electronic apparatus, communication is performed therebetween. If a subtle delay occurs in a signal reception timing at the certain external recording apparatus, which corresponds to a signal transmission timing at the certain electronic apparatus, the certain recording apparatus may fail in recording the data. However, such a failure may not occur between the certain electronic apparatus and another certain external recording apparatus.

However, in this case, users may not know that the certain electronic apparatus and the certain external recording apparatus of the former combination are incompatible, and that the certain electronic apparatus and another external recording apparatus of the latter combination are compatible. Accordingly, the user continues to utilize the incompatible combination (i.e., the combination of the certain electronic apparatus and the certain external recording apparatus), so that the user fails in recording the video data again.

### BRIEF DESCRIPTION OF THE DRAWINGS

FIG. 1 is a block diagram showing a configuration of a system including electronic apparatuses according to an embodiment.

FIG. 2 is a block diagram showing a configuration of the electronic apparatus according to the embodiment.

FIG. 3 is a diagram showing functions of the electronic apparatus according to the embodiment.

FIGS. 4A and 4B are tables each showing an example of information transmitted to a server in response to the checking of a connection status of an external device connected to the electronic apparatus according to the embodiment.

FIG. 5 is a table showing an example of information transmitted to the server when the electronic apparatus according to the embodiment fails in an operation of recording data in the external device connected thereto.

FIG. 6 is a table showing an example of information transmitted from the server to the electronic apparatus according to the embodiment.

FIG. 7 is a flowchart showing an operation of the electronic apparatus according to the embodiment.

FIG. 8 is a flowchart showing an operation of the server according to the embodiment.

FIG. 9 is a block diagram showing another example of the configuration of a system including electronic apparatuses according to an embodiment.

FIG. 10 is a diagram showing an example of messages concerning the combination of the electronic apparatus and the external recording device according to the embodiment, which are displayed in the electronic apparatus according to the embodiment.

### DETAILED DESCRIPTION OF THE EMBODIMENTS

In general, according to one exemplary embodiment, an electronic apparatus includes: a combination information output module which outputs, to a server, information according to a combination between the electronic apparatus and an external device externally connected to the electronic apparatus; a notification receiver which receives a notification according to the combination between the electronic apparatus and the external device, which is output from the server; and a display module which displays, in a display, information based on the notification.

Hereinafter, embodiments are described with reference to the drawings.

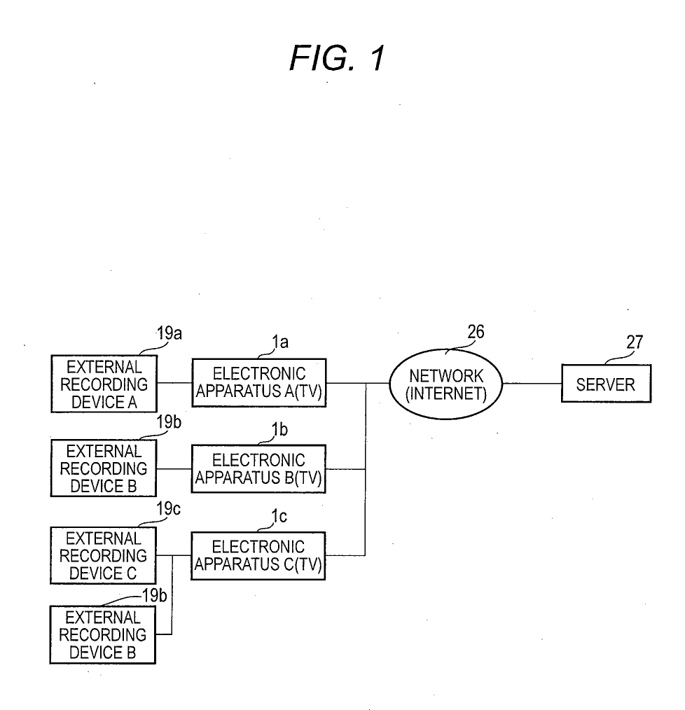

FIG. 1 is a block diagram showing a configuration of a system including electronic apparatuses according to an embodiment.

Reference numeral 1a designates an electronic apparatus A (television (TV) set), reference numeral 1b denotes an electronic apparatus B (TV set), reference numeral 1c represents an electronic apparatus C (TV set), reference numeral 19a designates an external recording device A, reference numeral 19b denotes an external recording device B, reference numeral 19c represents an external recording device C, reference numeral 26 designates a network (the Internet), and reference numeral 27 denotes a server.

In the embodiment, each of the electronic apparatus A (1a), the electronic apparatus B (1b), and the electronic apparatus C (1c) is a TV set to which one or more external devices can be externally connected.

The electronic apparatus A (1a), the electronic apparatus B (1b), and the electronic apparatus C (1c) are connected to an in-home LAN and to the server 27 via the Internet 26.

The external recording device A (19a) configured externally is connected to the electronic apparatus A (1a). The external recording device B (19b) configured externally is connected to the electronic apparatus B (1b). The external recording device C (19c) and the external recording device A (19a) configured externally are connected to the electronic apparatus C (1c).

In this system, the above in-home LAN is configured by wire cables or a wireless LAN.

In the embodiment, the connection status of the external device connected to each electronic apparatus is checked by the electronic apparatus on, e.g., a day-to-day basis. In addition, as will be described below, information concerning the connection between the electronic apparatus and the external device connected thereto, i.e., the combination of the electronic apparatus and the external device connected thereto is successively transmitted to the server 27.

The following description is made by employing a TV set (particularly, a digital TV set) as each electronic apparatus. However, e.g., a digital audio/video (AV) device, such as a digital versatile disc (DVD) recorder or a personal computer, can be employed as each electronic apparatus. The electronic apparatuses cause the external recording devices, which are respectively connected to the electronic apparatuses, to record video and audio content data (hereinafter referred to simply as contents).

In the following description, the term “external recording device” designates a recording device that is not incorporated in an electronic apparatus. The external recording devices are, e.g., USB-connected hard disk drive (HDD) apparatuses, LAN-connected HDD apparatuses, or USB-connected or LAN-connected DVD recorders.

That is, the external recording devices (19a, 19b, and 19c) can be connected directly to the electronic apparatuses, similarly to, e.g., the USB-connected HDD apparatuses. Alternatively, the external recording devices (19a, 19b, and 19c) can be connected to the electronic apparatuses via the in-home LAN, similarly to the LAN-connected HDD apparatuses.

Information concerning the external devices and the electronic apparatuses is transmitted to the server 27 from the electronic apparatus A (1a), the electronic apparatus B (1b), and the electronic apparatus C (1c).

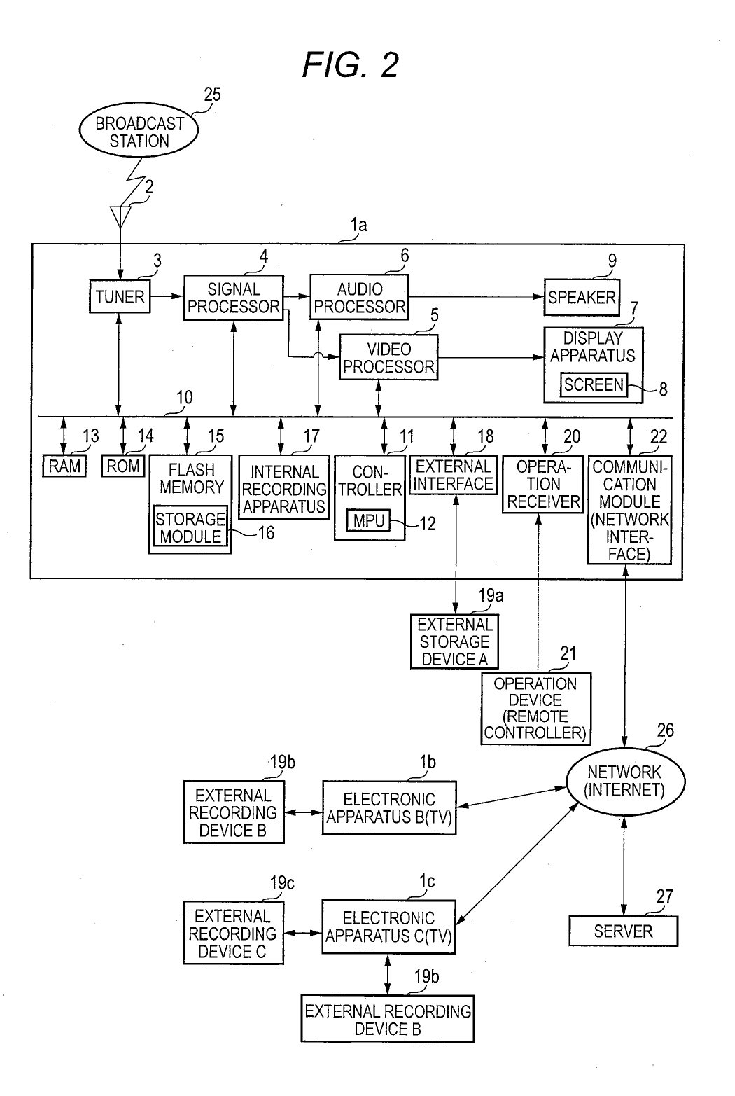

FIG. 2 is a block diagram showing the configuration of the electronic apparatus according to the embodiment.

According to the embodiment, a system including a plurality of electronic apparatuses, such as the electronic apparatus A (1a), the electronic apparatus B (1b), and the electronic apparatus C (1c), is configured, as described above. FIG. 2 shows the configuration of the electronic apparatus A (1a).

Reference numeral 2 designates an antenna, reference numeral 3 denotes a tuner, reference numeral 4 represents a signal processor, reference numeral 5 designates a video processor, reference numeral 6 denotes an audio processor, reference numeral 7 represents a display apparatus, reference numeral 8 designates a screen, reference numeral 9 denotes a speaker, reference numeral 10 represents a bus, reference numeral 11 designates a controller, reference numeral 12 denotes a micro-processor unit (MPU), reference numeral 13 represents a random access memory (RAM), reference numeral 14 designates a read-only memory (ROM), reference numeral 15 represents a flash memory, reference numeral 16 designates a storage module, reference numeral 17 denotes an internal storage apparatus, reference numeral 18 represents an external interface, and reference numeral 25 designates a broadcast station.

The controller 11 includes an MPU (12), and controls the electronic apparatus A (1a). The RAM (13) and the flash memory 15 are utilized for processing performed by the controller 11.

Video contents are broadcasted in a digital broadcast from, e.g., the broadcast station 25. The digital broadcast broadcasted from the broadcast station 25 is received by the tuner 3. Then, tuning processing is performed, so that video contents represented by digital signals are transmitted therefrom to the signal processor 4.

The video contents represented by the digital signal received by the signal processor 4 are subjected to signal processing. The processed video contents are transmitted to the audio processor 6 and the video processor 5.

The audio processor 6 receives the video contents subjected to the signal processing and transmits, to the speaker 9, signals subjected to audio processing.

The speaker 9 receives signals subjected to the audio processing and outputs sounds.

The video processor 5 receives the video contents subjected to the signal processing, and transmits to the display apparatus 7 signals subjected to video processing.

The display apparatus 7 receives the signals subjected to the video processing, and displays video-images on the display screen 8 configured by a liquid crystal display (LCD) panel or the like.

In this embodiment, the electronic apparatus 1a includes the internal storage apparatus 17, so that the received video contents can be recorded.

In addition, in this embodiment, the electronic apparatus 1a includes the USB-connected or LAN-connected external recording device A (19a). The received video contents can be recorded in the external recording device A (19a).

An operation performed by a user on the electronic apparatus 1a is instructed by an operation device 21, e.g., a remote control (remote controller).

As described above, such processing is controlled by the controller 11.

In addition, as described above, the electronic apparatus 1a is connected to the server 27 via the communication module (network interface) 22.

As will be described below, the electronic apparatus 1a transmits, to the server 27 via the Internet 26, information concerning the electronic apparatus 1a (e.g., the manufacturer, the product name, the model No., the serial No., the firmware version No., and the like of the electronic apparatus 1a) and information concerning the external recording device A (1a) (in this embodiment, the external recording device) externally connected to the electronic apparatus 1a (e.g., the manufacturer, the product name, the model No., the serial No., the firmware version No., the connection method, and the first connection date of the external recording device A).

Then, the electronic apparatus 1a causes the external device (external recording device A (1a)) externally connected to the electronic apparatus 1a itself to perform, e.g., a recording operation. For example, the electronic apparatus 1a causes the external recording device A (1a) to record video contents received from the digital broadcast.

The electronic apparatus 1a monitors an operation of recording video contents, which is performed by the external recording device A (1a).

If the electronic apparatus 1a determines that the electronic apparatus 1a fails in an operation of recording video contents in the external recording device A (1a), the electronic apparatus 1a transmits, to the server 27 via the Internet 26, information concerning the electronic apparatus 1a, and information concerning the external recording device A (1a) externally connected thereto, as described above.

Similarly, if each of the electronic apparatus 1b, the electronic apparatus 1c, and so on fails in an operation of recording video contents in the external recording device externally connected thereto, each of the electronic apparatuses transmits, to the server 27 via the Internet 26, information concerning the electronic apparatus itself and information concerning the external recording device externally connected thereto.

Then, the server 27 receives the information concerning the electronic apparatus itself and the information concerning the external recording device externally connected thereto, which are transmitted from a plurality of electronic apparatuses (1a, 1b, 1c, and so on), and analyzes the received information, as will be described below.

If the server 27 should notify a user of a message, e.g., “the possibility of occurrence of a failure in recording data in a certain recording device is high”, as a result of analysis, the server 27 transmits, to an electronic apparatus which should know such information, a notification such as a message.

When the electronic apparatus receives the above notification, the electronic apparatus displays information represented by the notification as it is. Alternatively, the electronic apparatus displays the information represented by the notification when data is newly recorded in an external recording device that is incompatible with the electronic apparatus if the external recording device is combined therewith.

According to an example of a modification of this embodiment, the system can be configured such that the server 27 generates information concerning the analyzed combination of the electronic apparatus and the external recording device (i.e., whether the electronic apparatus and the external recording device are compatible with each other) in, e.g., a list form, and transits this information to each electronic apparatus, and that then, the electronic apparatuses receive this information and individually make determination and send the above notifications such as a message.

According to this example, the system can be configured such that, e.g., the electronic apparatus A (1a) determines whether the electronic apparatus A (1a) itself is included in the list of the information concerning the combination (or the compatibility between the electronic apparatus and the external recording device), and that if the electronic apparatus A (1a) is included in the list, the electronic apparatus A (1a) performs a notification such as the message.

Alternatively, the system can be configured such that the electronic apparatus A (1a) uniquely sets a threshold of the possibility of occurrence of a failure in recording data so that if the possibility of occurrence of a failure is equal to or more than a threshold of, e.g., 80%, the electronic apparatus A (1a) sends a notification such as the above message, that if the possibility of occurrence of a failure is equal to or more than a threshold of, e.g., 90%, the electronic apparatus A (1a) sends a notification such as the above message, that the threshold is set at, e.g., 70%, or that the threshold is appropriately changeable.

The above processing, such as the transmission of the information, the notification, and the display of the information, to be performed corresponding to occurrence of a failure in the recording operation of the above external device (i.e., the external recording device A (1a)) can be applied to the case of occurrence of a failure in each of the deletion operation and the reproduction operation.

In addition, the recording operation of the above external device, the above processing corresponding to the failure of which is performed, is not limited to the recording of video contents. The deletion operation includes the deletion of video contents, and the reproduction operation includes the reproduction of video contents.

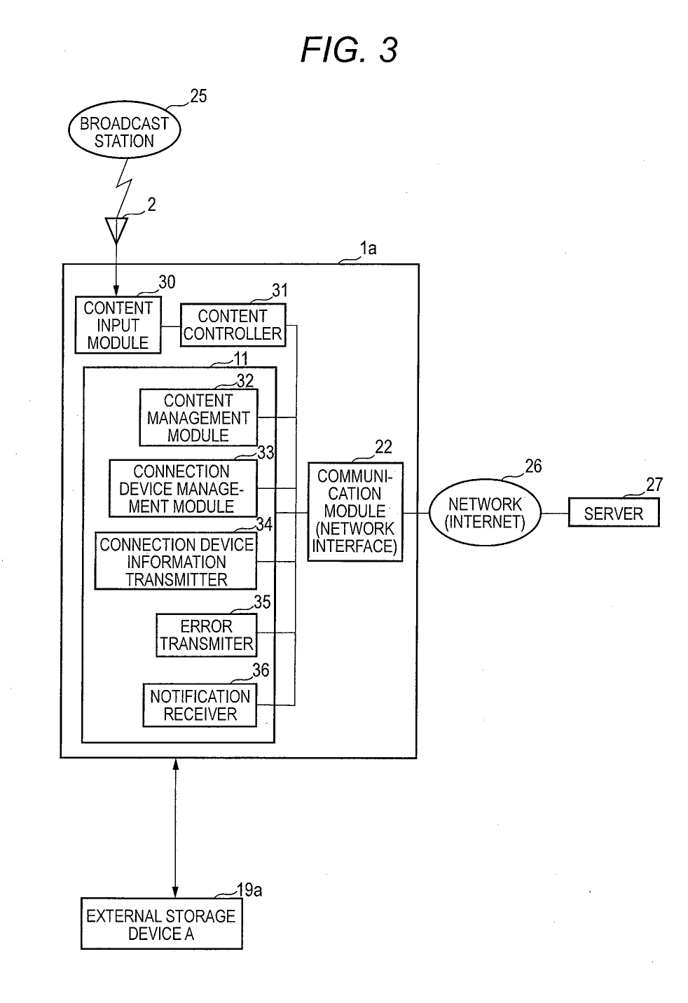

FIG. 3 is a diagram showing the functions of the electronic apparatus according to the embodiment.

Reference numeral 30 designates a content input module. Reference numeral 31 denotes a content controller. Reference numeral 32 represents a content management module. Reference numeral 33 designates a connection device management module. Reference numeral 34 denotes a connection device information transmitter. Reference numeral 35 represents an error transmitter. Reference numeral 36 designates a notification receiver.

For example, these components are configured in the electronic apparatus 1a. In addition, e.g., the content management module 32, the connection device management module 33, the connection device information transmitter 34, the error transmitter 35, and the notification receiver 36 are configured in the controller 11.

The content management module 32 manages the recording and the output of the video contents. The connection device management module 33 manages the connection status and the like of the external device A connected to the electronic apparatus 1a. The connection device information transmitter 34 transmits, to the server 27, information representing the connection status of the external device A connected to the electronic apparatus 1a, and the like.

If an operation of recording the video contents in the external recording device is failed, the error transmitter 35 transmits, to the server 27 via the Internet 26, information concerning the electronic apparatus itself and information concerning the external recording device externally connected thereto. The notification receiver 36 receives the above notification transmitted from the server 27.

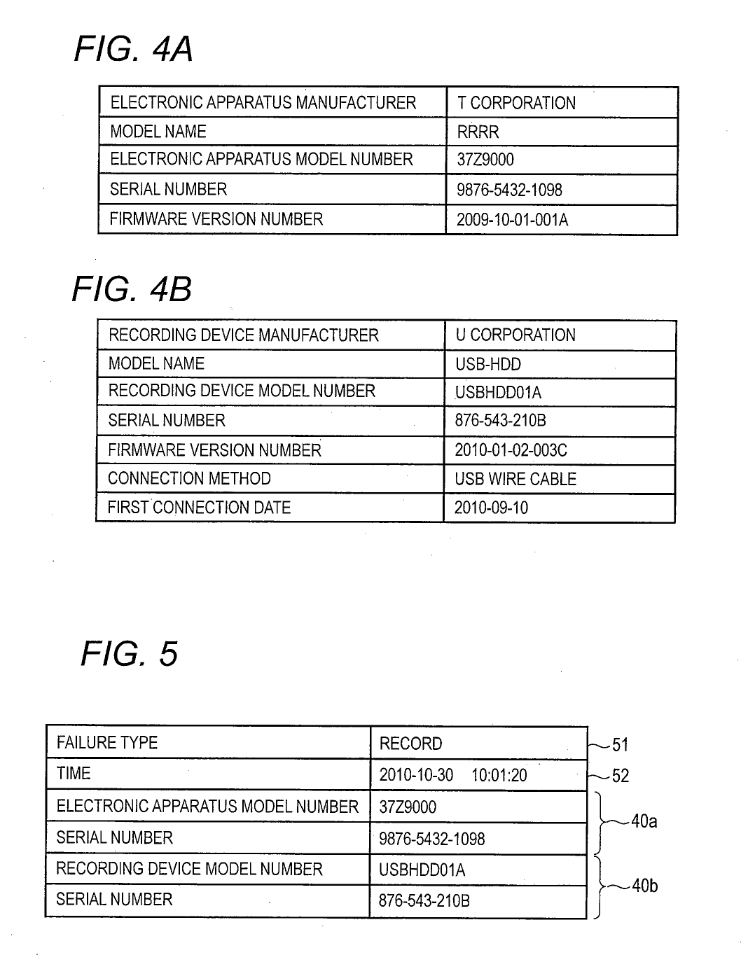

FIGS. 4A and 4B are tables each showing an example of information transmitted to the server in response to the checking of the connection status of the external device connected to the electronic apparatus according to the embodiment.

In this case, as described above, the connection status of the external device connected to the electronic apparatus according to the embodiment is checked. For example, the following information is transmitted to the server 27.

FIG. 4A shows an example of information concerning the electronic apparatus.

In this case, as described above, information transmitted to the server 27 from the electronic apparatus 1a includes the manufacturer or vender “T corporation”, the model name “RRRR”, the model number “37Z9000”, the serial number “9876-5432-1098”, and the firmware version number “2009-10-01-001A”. These types of information include information for identifying the electronic apparatus 1a.

FIG. 4B shows an example of information concerning the external device connected to the electronic apparatus.

In this case, the external device connected to the electronic apparatus is the external device A (19a).

In this case, information transmitted from the external device A (19a) to the server 27 includes an external device recording device manufacturer “U Corporation”, a model name “USB-HDD”, a model number “USBHDD01SA”, a serial number “876-543-210B”, the firmware version number “2010-01-02-003C”, a method for connecting the external device to the electronic apparatus “USB wire cable”, and a first date on which the external device is first connected to the electronic apparatus is “2010-09-10”. These types of information include information for identifying the external device A (19a) connected to the electronic apparatus.

As long as the above information includes information according to which the electronic apparatus and the external device can be identified, the model name, the serial No., and so on can be omitted. However, the above information can include, e.g., another type of information (e.g., the media access control (MAC) address of a network interface and the like) for identifying the electronic apparatus.

FIG. 5 is a table showing an example of information transmitted to the server when the electronic apparatus according to the embodiment fails in an operation of recording data in the external device connected thereto.

In this case, as designated with reference numeral 51, it is recorded in the electronic apparatus that the electronic apparatus has failed in an operation of recording data in the external device connected thereto, and that the time at which the electronic apparatus has failed in this operation is “Oct. 30, 2010, at 10:01:20”. This record is transmitted from the electronic apparatus to the server 27 as information.

At that time, e.g., information representing the combination of the electronic apparatus and the recording device (i.e., information designated with reference numeral 40a, which represents the electronic apparatus, and information designated with reference numeral 40b, which represents the recording device) is also transmitted thereto.

In this case, e.g., information representing the electronic apparatus is the electronic apparatus number “37Z9000” and the serial number “9876-5432-1098”, which have been described with reference to FIGS. 4A and 4B.

In addition, e.g., information representing the recording device is the model number “USBHDD01A” and the serial number “876-543-210B”, which are also described with reference to FIGS. 4A and 4B.

However, all information described with reference to FIGS. 4A and 4B can be transmitted as information representing the combination of the electronic apparatus and the recording device.

That is, information representing the electronic apparatus is the electronic apparatus manufacturer “T corporation”, the model name “RRRR”, the model number “37Z90000”, the serial number “9876-5432-1098”, and the firmware version number “2009-10-01-001A”.

In addition, information representing the external device is the external recording device manufacturer “U corporation”, the model name “USB-HDD”, the model number “USBHDD01A”, the serial number “876-543-210B”, the firmware version number “2010-01-02-003C”, the method for connecting the external device to the electronic apparatus, which is “USB wire cable”, and the first connection date at which the external device is connected to the electronic apparatus, which is “2010-09-10”.

As described above, the server 27 receives information transmitted from a plurality of electronic apparatuses (the electronic apparatus A (1a), the electronic apparatus B (1b), the electronic apparatus C (1c), and so on), i.e., information transmitted to the server 27 in response to the checking of the connection status of the external device connected to each electronic apparatus.

The server 27 receives information which is transmitted from each of the electronic apparatuses and which represents the combination of the electronic apparatus failing in recording data, and the external recording device. The server 27 stores the received information.

Then, the server 27 analyzes the stored information. Thus, a user can know what combination between the electronic apparatus and the external device connected thereto fails in recording data in the external device at what degree of probability.

For example, the system is set such that when the probability of failing in recording, i.e., occurrence of an error (i.e., (the number of the combinations at each of which an error occurs)/(a total number of the combinations)×100) on a certain day in the case of the combination of a certain electronic apparatus A (1a) and a certain external recording device A (19a) exceeds a certain reference value of 80%, the server 27 transmits, to all the electronic apparatuses A (1a) respectively corresponding to such combinations, a message, i.e., a notification indicating that each of such electronic apparatuses A (1a) should be avoided from being combined with the external recording devices A (19a) corresponding to such combinations.

At that time, the number of the combinations at each of which an error occurs is that of the combinations, from the electronic apparatus of each of which the server 27 actually receives information indicating that the recording of video contents in the associated external recording device is failed.

In this case, e.g., each electronic apparatus is uniquely specified according to the electronic apparatus model number (“37Z9000”) and the serial number (“9876-5432-1098”), which are illustrated in FIGS. 4A and 4B. In addition, each external recording device is uniquely specified according to the recording device model number (“USBHDD01A”) and the serial number (“876-543-210B”).

The total number of the combinations represents the number of all the combinations between the uniquely specified electronic apparatuses and the uniquely specified external recording devices. The number of the combinations at each of which an error occurs is that of the combinations each of which causes an error.

The total number of the combinations is that of the combinations between the uniquely specified electronic apparatuses and the uniquely specified external devices, the respective of which are represented by pieces of information, which are illustrated in FIGS. 4A and 4B and successively transmitted from the electronic apparatuses to the server 27.

Because each electronic apparatus and each external recording device are uniquely specified, respectively, as described above, the electronic apparatus and the external recording device of the same combination can be prevented from being repeatedly connected to each other. In addition, occurrences of failures in recording at the same combination can be prevented from being redundantly counted.

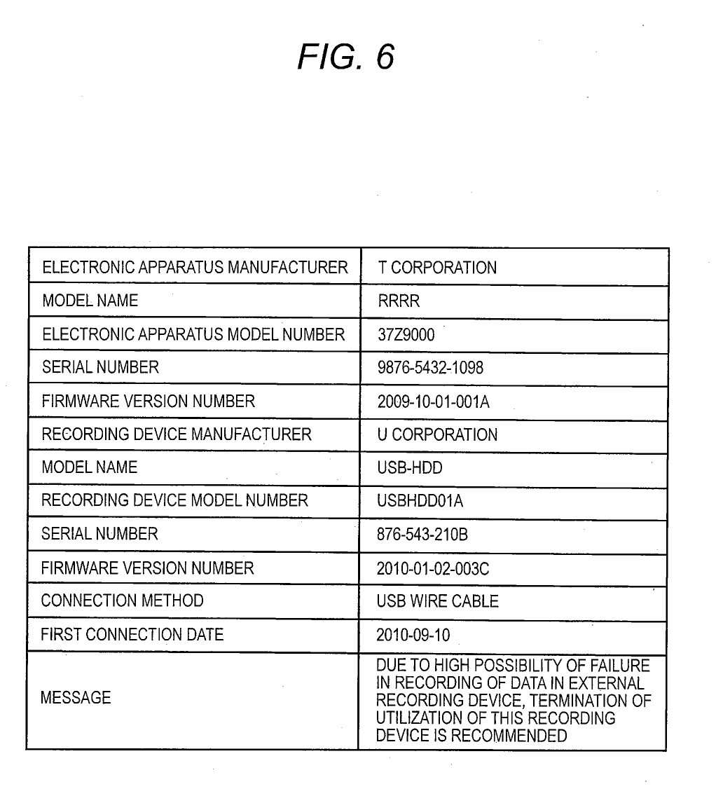

FIG. 6 is a table showing an example of information transmitted from the server to the electronic apparatus according to the embodiment.

As described above, the server 27 notifies the electronic apparatus 1a of, e.g., a message “Due to the high possibility of failure in recording of data in the external recording device A (19a), the termination of utilization of this recording device is recommended”.

When receiving this notification, the electronic apparatus 1a displays this information on, e.g., the screen 8 of the display apparatus 7.

In this case, the server 27 transmits to the electronic apparatus 1a information concerning the electronic apparatus and the external connection device, in addition to this notification.

That is, similarly to the above case, e.g., information concerning the electronic apparatus is the electronic apparatus manufacturer “T corporation”, the model name “RRRR”, the model number “37Z9000”, the serial number “9876-5432-1098”, and the firmware version number “2009-10-01-0001A”.

Information concerning the external device is the external recording device manufacturer “U corporation”, the model name “USB-HDD”, the model number “USBHDD01A”, the serial number “876-543-210B”, the firmware version number “2010-01-02-003C”, the method for connecting the external device to the electronic apparatus, which is “USB wire cable”, and the first connection date on which the external device is first connected to the electronic apparatus, which is “2010-09-10”.

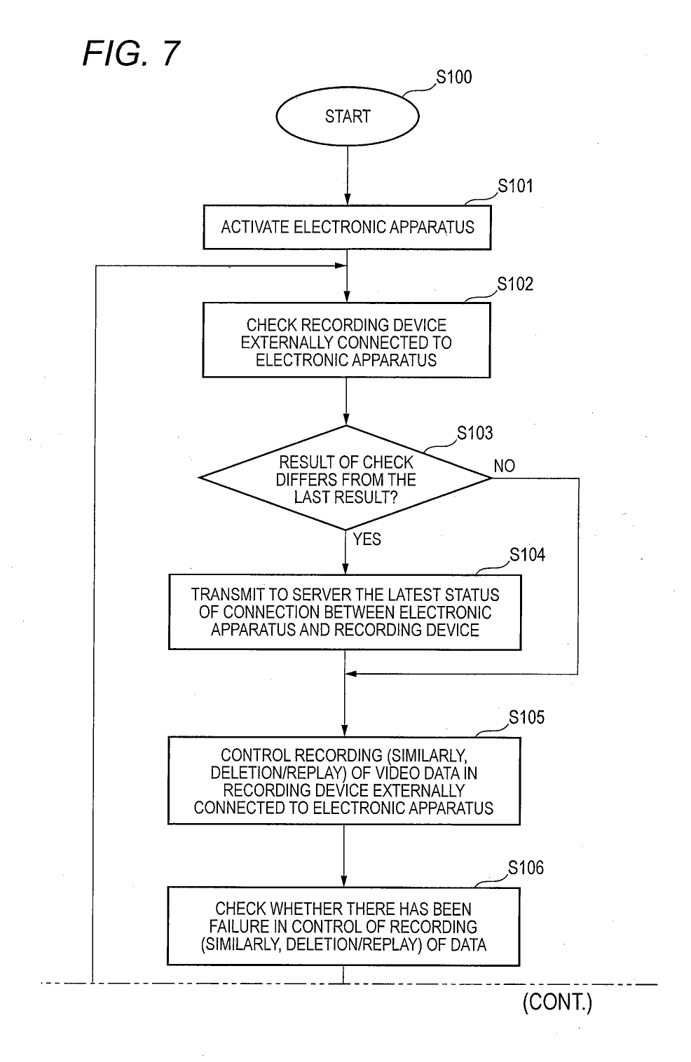

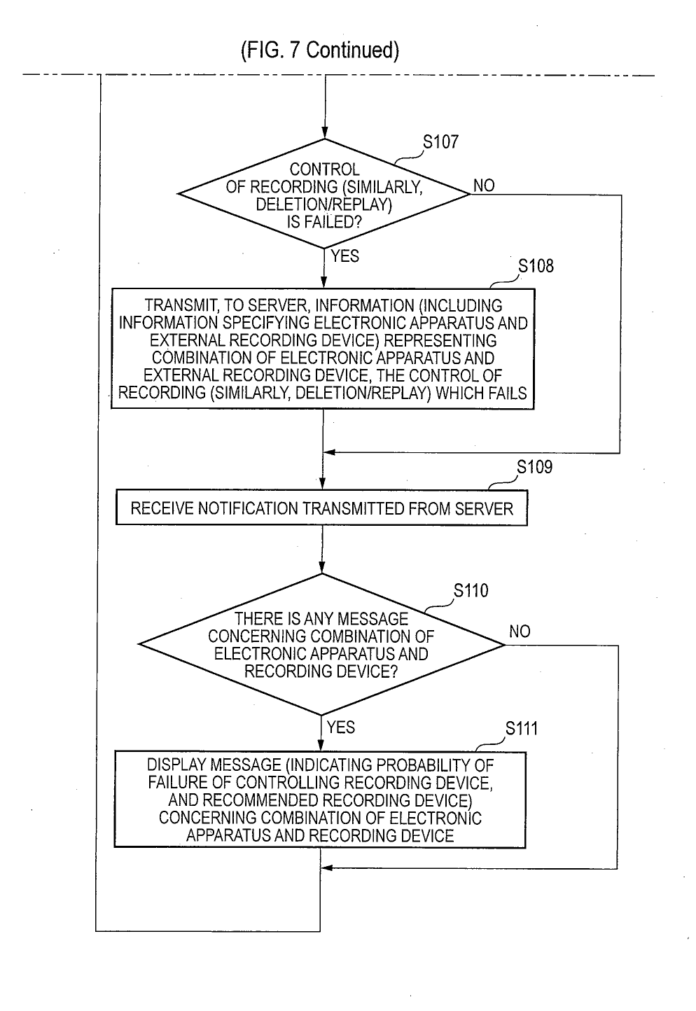

FIG. 7 is a flowchart showing an operation of the electronic apparatus according to the embodiment.

Hereinafter, a certain electronic apparatus is referred to as an electronic apparatus. A recording device externally connected to the electronic apparatus is referred to as an external recording device or as an external device.

Reference numeral S100 designates a start step of this process. Then, the process proceeds to a step designated with reference numeral S101.

Reference numeral S101 is a step in which the electronic apparatus (a digital TV in this case) is activated. Then, the process proceeds to a step designated with reference numeral S102.

Reference numeral S102 designates a step in which the recording device externally connected to the electronic apparatus is checked. The electronic apparatus checks, e.g., every day, what the external recording device externally USB-connected or LAN-connected to the electronic apparatus is. A result of the check is recorded in, e.g., the storage module 16 of the flash memory 15. Then, the process proceeds to a step designated with reference numeral S103.

Reference numeral S103 designates a step in which it is checked whether the current check result differs from the last check result. As described above, the electronic apparatus compares the current check result with the last check result obtained one day earlier to check whether the electronic apparatus is connected to the external recording device which is the same as the last external recording device connected to the electronic apparatus. If the external recording device currently connected to the electronic apparatus differs from that last recording device externally connected to the electronic apparatus (Yes in step S103), the process proceeds to step designated with reference numeral S104. If the external recording device currently connected to the electronic apparatus is the same as the last recording device externally connected to the electronic apparatus (No in step S103), the process proceeds to step designated with reference numeral S105. The electronic apparatus can be configured to transmit to the server 27 information indicating that the external device currently connected to the electronic apparatus is the last external device externally connected thereto.

Reference numeral 104 designates a step in which the checked latest connection-status of the connection between the electronic apparatus and the recording device is transmitted to the server 27. Then, the process proceeds to a step designated with reference numeral S105.

Reference numeral S105 designates with a step in which the electronic apparatus performs a recording-control operation of controlling video data such as video contents to be recorded in the recording device externally connected to the electronic apparatus. As described above, the above processing to be performed corresponding to occurrence of a failure in the recording-control operation is similarly performed in the case of failing in a deleting-control operation or a reproducing-control operation. Then, the process proceeds to a step designated with reference numeral S106.

Reference numeral S106 designates a step in which the electronic apparatus checks data recorded in the external recording device and determines whether the electronic apparatus fails in a recording-control operation of controlling data to be recorded in the external recording device. Then, the process proceeds to a step designated with reference numeral S107.

Reference numeral S107 designates a step in which the electronic apparatus determines whether the electronic apparatus fails in a recording-control operation. If a failure of the recording-control operation occurs (Yes in step S107), the process proceeds to a step designated with reference numeral S108. If no failure of the recording-control operation occurs (No in step S107), the process proceeds to a step designated with reference numeral S109. As described above, the processing to be performed in the case of failing in a recording-control operation is similarly performed in the case of failing in a deleting-control operation or a reproducing-control operation.

The electronic apparatus can be configured to transmit to the server 27 information indicating the combinations between the electronic apparatus, which succeeds in the recording-control operation (or the deleting-control operation or the reproducing-control operation), and the external recording device (the information includes information specifying the electronic apparatus and the recording device).

Reference numeral S108 designates a step in which the electronic apparatus transmits, to the server 27, information concerning both the electronic apparatus, which fails in a recording-control operation, and the external recording device externally connected thereto, and serving substantially as the combination information.

As described above with reference to, e.g., FIG. 5, when a certain electronic apparatus fails in a recording-control operation of controlling data to be recorded in a certain external device, the electronic apparatus transmits to the server 27 information indicating that a failure of the recording operation occurs in the case of the combination between the certain electronic apparatus and the certain external device.

In the above example, the electronic apparatus transmits to the server 27 information indicating that the electronic apparatus fails in the recording operation of recording data in the external device (refer to reference numeral 51 in FIG. 5), and that the time at which the electronic apparatus fails in the recording operation is “Oct. 30, 2010 at 10:01:20” (refer to reference numeral 51 in FIG. 5).

At that time, the electronic apparatus also transmits, e.g., combination information representing the combination between the electronic apparatus and the recording device (i.e., information 40a concerning the electronic apparatus, and information 40b concerning the recording device), as described above.

In this case, the information concerning the electronic apparatus is the electronic apparatus model number “37Z90000” and the serial number “9876-5432-1098”, as described above with reference to FIGS. 4A and 4B.

The information concerning the above recording device is the model number “USBHDD01A” and the serial number “876-543-210B”.

In addition, as described above, all the information described with reference to FIGS. 4A and 4B can be transmitted as the combination information concerning the combination between the electronic apparatus and the recording device.

Such information includes information according to which the electronic apparatus and the recording device can be identified. As described above, the processing to be performed in the case of failing in a recording-control operation is similarly performed in the case of failing in a deleting-control operation or a reproducing-control operation. Then, the process proceeds to a step designated with reference numeral S109.

As described above, the server 27 receives and stores, e.g., information that concerns the combination between the electronic apparatus, which fails in the recording operation, and the external recording device, and that is transmitted by each of the electronic apparatuses.

Then, the server 27 analyzes the stored information and knows what combination between the electronic apparatus and the external device connected thereto fails in a recording operation in the external device at what degree of probability.

Then, the server 27 transmits a notification such as a message illustrated in FIG. 10 to the electronic apparatus corresponding to the combination at which the degree of probability of failing in a recording operation is high (e.g., equal to or higher than 80%).

Reference numeral S109 designates a step in which the electronic apparatus receives a notification such as a message transmitted from the server 27. Then, the process proceeds to step S110.

Reference numeral S110 designates a step in which the electronic apparatus determines whether there is a message concerning the combination between the above electronic apparatus and the external recording device externally connected thereto. If there is a message concerning the combination between the above electronic apparatus and the external recording device externally connected thereto (Yes in step S110), the process proceeds to a step designated with reference numeral S111. If there is no message concerning the combination between the above electronic apparatus and the external recording device externally connected thereto (No in step S110), the process proceeds to a step designated with reference numeral S102. Then, the above process is repeated.

Reference numeral S111 designates a step in which a message concerning the combination between the electronic apparatus and the external recording device externally-connected thereto is displayed in a video-image display module of the electronic apparatus. The message concerns, e.g., the probability of occurrence of an anticipated failure of control of the external recording device, and also concerns a recommended external recording device.

As illustrated in, e.g., FIG. 10, a message concerning the combination of the electronic apparatus and the external recording device is, e.g., “the combination of the electronic apparatus A and an external recording device A is high in the probability of occurrence of a failure in recording. Currently, recording fails at the possibility of 80%”.

Alternatively, a message, whose contents concern a recommended external recording device, can be transmitted. The message is, e.g., “the utilization of an external recording device “USBHDD100B” manufactured by “U corporation” is recommended, because the combination of the electronic apparatus and the external recording device is small in the number of reports of a failure in a recording operation.”

In this case, FIG. 10 shows an example of a message displayed on the display screen of the electronic apparatus A (1a). Then, the process proceeds to a step designated with reference numeral S102. After that, the above process is repeated.

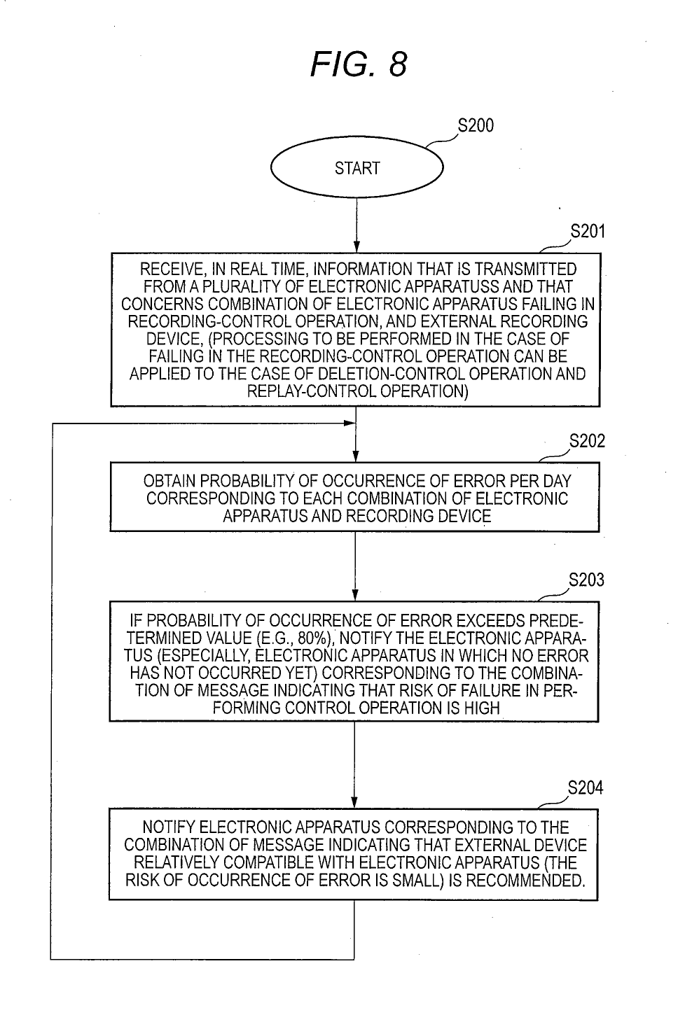

FIG. 8 is a flowchart showing an operation of the server according to the embodiment.

Reference numeral S200 designates a start step of this process. Then, the process proceeds to a step designated with reference numeral S201.

Reference numeral S201 designates a step in which the server 27 receives, in real time, information that is transmitted from a plurality of electronic apparatuses and that concerns the combination of the electronic apparatus failing in a recording-control operation, and the external recording device. Similarly to the above case, processing to be performed in the case of failing in the recording-control operation can be applied to the cases of failing in the deletion-control operation, and the reproduction-control operation. Then, the process proceeds to a step designated with reference numeral S202.

Reference numeral S202 designates a step in which the probability of occurrence of an error (i.e., the probability of failing in a recording-control operation) per day corresponding to each combination of the electronic apparatus and the recording device is obtained by the server 27.

The probability of occurrence of an error is obtained by, e.g., finding the probability of failing in a recording-control operation, i.e., occurrence of an error (the number of the combinations at each of which an error occurs)/(a total number of the combinations)×100) on a certain day in the case of the combination of an electronic apparatus and an external recording device, as described above. The number of the combinations in each of which an error occurs is that of the combinations, which is indicated by the information that the server 27 actually receives, as described above.

The total number of the combinations is that of the combinations between the uniquely specified electronic apparatuses and the uniquely specified external devices, the respective of which are represented by pieces of information, which are illustrated in FIGS. 4A and 4B and successively transmitted from the electronic apparatuses to the server 27. Then, the process proceeds to a step designated with reference numeral S203.

Reference numeral 5203 designates a step in which when the probability of occurrence of an error exceeds a certain reference value of 80%, it is determined that the electronic apparatus and the external recording device are incompatible, and in which the server 27 notifies, e.g., such combinations' electronic apparatuses of a message indicating that the possibility of such an electronic apparatus's failure in performing a recording operation or the like is high.

This notification is effective information for other electronic apparatuses each of which is combined with an external recording device having the same model number as that of the external recording device combined with the electronic apparatus failing in a recording operation and which has not caused an error yet. This is because a failure in a recording operation, which would occur in each of the other electronic apparatuses at high risk in future, can be avoided. Then, the process proceeds to step designated with reference numeral 5204.

Reference numeral 5204 designates a step in which the server 27 notifies the electronic apparatus of the above combination of a message indicating that an external device relatively compatible with the electronic apparatus is recommended. For example, an external recording device of a combination which is low in the possibility of occurrence of an error is selected as the external device compatible with the electronic apparatus.

Then, as described above, the server 27 transmits, to the corresponding electronic apparatus, a message “the utilization of an external recording device USBHDD100B manufactured by “U corporation” is recommended, because the combination of the electronic apparatus and the external recording device is small in the number of reports of a failure in a recording operation.” Then, the process proceeds to a step designated with reference numeral S202. After that, the above process is repeated.

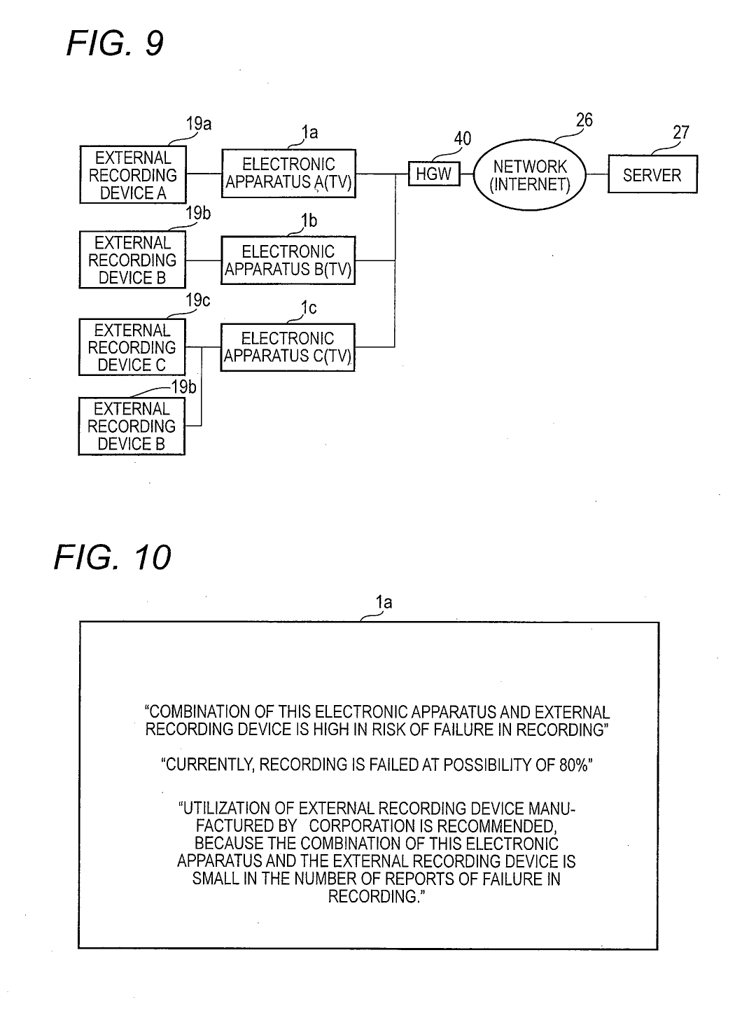

FIG. 9 is a block diagram showing another example of the configuration of a system including electronic apparatuses according to an embodiment of the invention.

In this embodiment, the electronic apparatus A (1a) has a built-in home gateway (HGW) designated with reference numeral 40. The HGW 40 has the functions of managing and controlling an in-home LAN.

For example, the HGW 40 can control and reduce communication traffic with the server 27. In addition, information such as a notification transmitted from the server 27 can be assured in the HGW 40 by maintaining the HGW 40 in an operating condition in a state in which the main power supply of the electronic apparatus A (1a) is turned off. For example, the HGW 40 can collect information transmitted from another electronic apparatus connected to this in-home LAN and can transmit the collected information to the server 27 via the Internet 26.

At that time, the server 27 can receive information transmitted from the HGW 40 and can obtain the probability of occurrence of an error to determine the combination of the electronic apparatus and the external recording device are incompatible with each other, and the combination of the electronic apparatus and the external recording device are compatible with each other, similarly to the above case.

If information representing the combination between the electronic apparatus failing in recording data in the server 27, and the external recording device is stored to some extent, the server 27 can appropriately transmit to the electronic apparatus the notification such as the above message.

For example, in a state in which information concerning the combination of the electronic apparatus and the external recording device is stored to some extent, immediately in response to the reception of the information concerning the connection between the electronic apparatus and the external device, the server 27 can transmit, to the electronic apparatus receiving the above notification, a notice such as a message.

With the above configuration, according to the embodiment of this invention, when the external recording device externally connected to the electronic apparatus fails in a recording-control operation or the like (similarly, the external recording device externally connected to the electronic apparatus fails in a deleting-control operation, and the external recording device externally connected to the electronic apparatus fails in a reproducing-control operation), the electronic apparatus transmits, to the server, information representing such a fact to determine the combination of the electronic apparatus and the external recording device, which are incompatible with each other, and the combination of the electronic apparatus and the external recording device, which are compatible with each other.

Then, the electronic apparatus can preliminarily know the compatibility between the electronic apparatus and the external recording device, which is indicated by information transmitted from the server.

Consequently, a user can alleviate the problems that the user iteratively utilizes the combination between the electronic apparatus and the external recording device while the cause of the failure remains unknown, and that the failure of performing, e.g., a recording operation is performed.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a combination information output module configured to output, to a server, information according to a combination between the electronic apparatus and an external device externally connected to the electronic apparatus;
a notification receiver configured to receive a notification according to the combination between the electronic apparatus and the external device, which is output from the server; and
a display module configured to display, in a display, information based on the notification.

2. The apparatus of claim 1, wherein the combination information output module is configured to output, to the server, information according to the combination between the electronic apparatus and the external device which fails in an operation.

3. The apparatus of claim 2, wherein the operation of the external device includes at least one of a data recording operation, a data deleting operation, and a data replaying operation of the external device externally connected to the electronic apparatus.

4. The apparatus of claim 1 further comprising:
a checking module configured to check the external device externally connected to the electronic apparatus,
wherein the checking module is configured to output, to the server, information representing a connection status of the checked external device.

5. The apparatus of claim 1 further comprising:
a checking module configured to check the external device externally connected to the electronic apparatus,
wherein the checking module is configured to detect failure in an operation of the external device checked to be externally connected to the electronic apparatus.

6. The apparatus of claim 1, wherein the display module is configured to display the received notification concerning the combination between the electronic apparatus and the external device.

7. A control method comprising:
outputting to a server information according to information concerning a combination between an electronic apparatus and an external device externally connected to the electronic apparatus;
receiving a notification according to the combination between the electronic apparatus and the external device, which is output from the server; and
displaying, in a display, information based on the notification.
